(19) United States
(12) Patent Application Publication
(10) Pub. No.: US 2005/0277435 A1
(43) Pub. Date: Dec. 15, 2005

(54) Portable digital communication apparatus

(75) Inventors: Hyoung-Shin Park, Seoul (KR); Jun-Sang Park, Anyang-si (KR); Chang-Soo Lee, Incheon (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/136,927

(22) Filed: May 25, 2005

(30) Foreign Application Priority Data
Jun. 11, 2004 (KR) 43047/2004

(51) Int. Cl. H04M 1/00

(52) U.S. Cl. 455/550.1; 455/575.1

(57) ABSTRACT

A portable digital communication apparatus includes a first housing; a second housing; a dual-axis hinge member connected to the first housing in such a manner that it can rotate about a first hinge axis and connected to the second housing in such a manner that it can rotate about a second hinge axis which is parallel to the first hinge axis to rotatably connect the first and second housings to each other; at least one coupler for connecting the dual-axis hinge member on the first and second housings; and at least one retainer positioned on the dual-axis hinge member to maintain a retaining position.

### PRIORITY

This application claims priority to an application entitled “Portable Digital Communication Apparatus” filed with the Korean Intellectual Property Office on Jun. 11, 2004 and assigned Serial No. 2004-43047, the contents of which are hereby incorporated by reference.

### BACKGROUND OF THE INVENTION

1. Field of the Invention

The present invention relates to digital communication apparatuses including cellular phones, PDAs (personal digital assistants), HHPs (handheld phones), game phones, Internet phones, and camera phones, and more particularly to a folder-type digital communication apparatus that is stable when charging its batteries and has the appearance and feel of a digital camera.

2. Description of the Related Art

In general, a “portable communication apparatus” refers to an electronic apparatus a user can carry to perform wireless communication with a desired partner. In consideration of portability, designs of such portable communication apparatuses are not only compact, slim, and light, but also include multimedia availability, having a wider variety of functions. Future portable communication apparatuses are expected to incorporate even greater multi-functionality and multi-purpose utilization in an even more smaller size. They will also be modified for various multimedia or Internet environments. Such portable communication apparatuses are now commonly used by people of all ages and walks of life, throughout the world, and are recognized by some people as a nearly indispensable commodity.

Conventional portable communication apparatuses may be classified into various categories according to their appearance, such as bar-type portable communication apparatuses, flip-type portable communication apparatuses, and folder-type portable communication apparatuses. The bar-type communication apparatuses have a single housing shaped like a bar. The flip-type communication apparatuses have a flip that is rotatably coupled to a bar-shaped housing by a hinge device. The folder-type communication apparatuses have a folder connected to a single bar-shaped housing by a hinge device in such a manner that the folder can be rotated to fold on or unfold from the housing.

Portable communication apparatuses may also be worn on the neck or wrist. The neck wearable type communication apparatus is one which a user wears around the neck on a string, while the wrist wearable type communication apparatus is one which a user wears around the wrist.

In addition, portable communication apparatuses may be classified into rotation-type and sliding-type according to the ways of opening and closing the communication apparatuses. In the rotation-type portable communication apparatuses, two housings are coupled to each other in such a manner that one housing rotates to be opened or closed relative to the other while they face each other. In the sliding-type portable communication apparatuses, two housings are coupled to each other in such a manner that one housing slides along a longitudinal direction to be opened or closed relative to the other. These variously classified portable communication apparatuses can be easily understood by those skilled in the art.

Conventional portable communication apparatuses transmit data at high speeds in addition to voice communication with wireless communication technology capable of transmitting data at a high speed.

Many portable communication apparatuses include a camera lens for transmission of video signals. An external or imbedded camera lens module enables video communication or photography.

Among conventional portable communication apparatuses, however, flip-type or folder-type portable apparatuses having two housings adapted to be opened/closed by a hinge device are unstable. When they are set on a charger, in particular, they must be accurately inserted into a slot formed on the charger at an angle. Such a retaining operation requires great care on the part of the user. In addition, the means for retaining them during charging is provided on the main body in the shape of a groove degrading the aesthetic appearance of the apparatuses.

### SUMMARY OF THE INVENTION

Accordingly, the present invention has been made to solve the above-mentioned problems occurring in the prior art, and an object of the present invention is to provide a portable digital communication apparatus adapted to be opened/closed by a dual-axis hinge member for convenient use in digital camera photography.

Another object of the present invention is to provide a portable digital communication apparatus having a dual-axis hinge member provided with a holding means for stability when retaining the apparatus during charging.

Another object of the present invention is to provide a portable digital communication apparatus having a dual-axis hinge member provided with a holding means for aesthetic overall appearance.

Another object of the present invention is to provide a portable digital communication apparatus with the feel of a high-quality digital camera.

In order to accomplish this object, there is provided a portable digital communication apparatus including a first housing; a second housing; a dual-axis hinge member connected to the first housing in such a manner that it can rotate about a first hinge axis and connected to the second housing in such a manner that it can rotate about a second hinge axis which is parallel to the first hinge axis to rotatably connect the first and second housings; at least one coupling means for accommodating the dual-axis hinge member on the first and second housings, respectively; and at least one holding means positioned on the dual-axis hinge member to maintain a retaining position.

In accordance with a further aspect of the present invention, there is provided a portable digital communication apparatus including a plate-shaped first housing; a plate-shaped second housing adapted to be positioned on top of the first housing when completely folded and to be positioned parallel to the first housing when completely unfolded; and at least one dual-axis hinge member having a retaining groove of a predetermined shape to maintain a retaining position during charging and rotatably connected to the first and second housings, respectively.

### BRIEF DESCRIPTION OF THE DRAWINGS

The above and other objects, features and advantages of the present invention will be more apparent from the following detailed description taken in conjunction with the accompanying drawings, in which:

FIGS. 1 and 2 are perspective views showing a portable digital communication apparatus with its second housing completely folded on the first housing according to a preferred embodiment of the present invention;

FIG. 3 is a front view of the portable digital communication apparatus shown in FIG. 1;

FIGS. 4 and 5 are perspective views showing a portable digital communication apparatus with its second housing completely unfolded from the first housing according to a preferred embodiment of the present invention;

FIG. 6 is a perspective view showing a portable digital communication apparatus retained on a charger according to a preferred embodiment of the present invention; and

FIGS. 7 to 10 are perspective views showing successively the stepwise opening/closing procedure of a portable digital communication apparatus according to a preferred embodiment of the present invention, wherein FIGS. 7 and 8 show the rotation abut a first hinge axis and FIGS. 9 and 10 show the rotation about a second hinge axis.

### DETAILED DESCRIPTION OF THE PREFERRED EMBODIMENT

Hereinafter, a preferred embodiment of the present invention will be described with reference to the accompanying drawings. In the following description of the present invention, a detailed description of known functions and configurations incorporated herein will be omitted when it may make the subject matter of the present invention unclear.

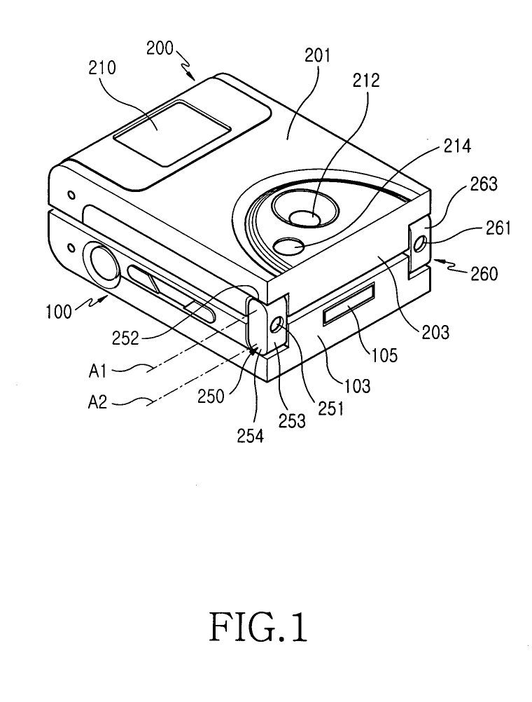

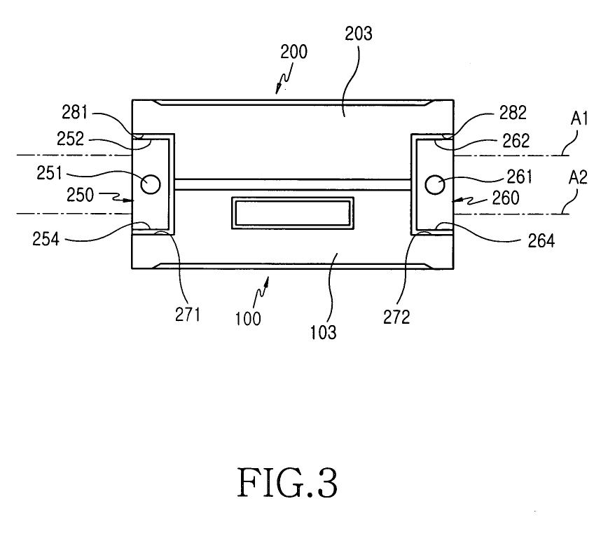

As shown in FIGS. 1 to 4, a portable digital communication apparatus according to the present invention includes a plate-shaped first housing 100; a second housing 200 connected to the first housing 100 in such a manner that it can rotate about first and second hinge axes A1 and A2; dual-axis hinge members 250 and 260 for connecting the first and second housings 100 and 200 to each other in such a manner that they can rotate about the first and second hinge axes A1 and A2; coupling means 271, 272, 281, and 282 (shown in FIG. 3) for accommodating the rotation of the dual-axis hinge members 250 and 260; and at least one holding means 251 and 261 positioned on the dual-axis hinge members 250 and 260 to retain the apparatus in such a manner that it is positioned in the vertical direction or slightly slanted from the vertical direction during charging or communication.

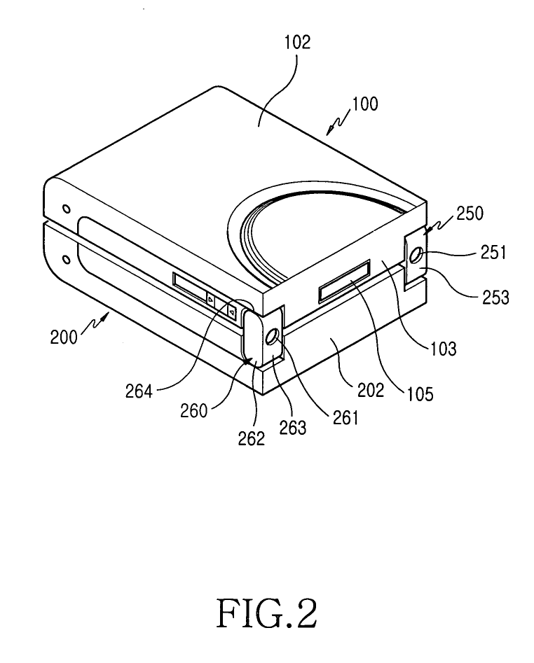

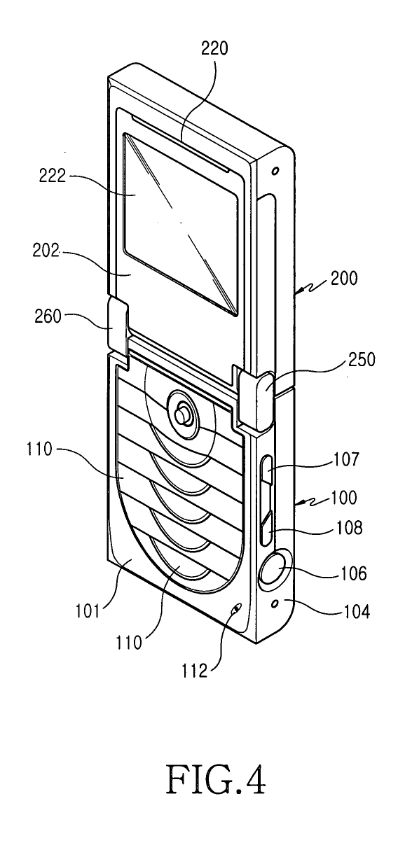

The first housing 100 has a top surface 101 (shown in FIG. 4), a bottom surface 102 (shown in FIG. 2), and a front end surface 103. The top surface 101 and bottom surface 102 are perpendicular to the front end surface 103. The front end surface 103 has a port 105 positioned thereon for connection with a charger when the apparatus is retained on the charger for charging.

The second housing 200 has a top surface 201 (shown in FIG. 1), a bottom surface 202 (shown in FIG. 4), and a front end surface 203. The top surface 201 has an auxiliary display device 210 positioned thereon, a camera lens 212 positioned adjacent to the auxiliary display device 210, and a lighting device 214 positioned adjacent to the camera lens 212. The top surface 201 and bottom surface 202 are perpendicular to the front end surface 203. The auxiliary display device 210 is preferably made up of an LCD. The auxiliary display device 210 display information which needs to be frequently checked without unfolding the second housing 200, for example time, date, arrival of message, battery's charging level, and antenna's receptivity.

A pair of dual-axis hinge members 250 and 260 are positioned between the first and second housings 100 and 200 symmetrical in both the vertical and horizontal planes. Particularly, the dual-axis hinge members include a first dual-axis hinge member 250 and a second dual-axis hinge member 260 positioned symmetrically to the first dual-axis hinge member 250.

The first dual-axis hinge member 250 has an end 252 connected to the second housing 200 in such a manner that the end 252 can rotate about the first hinge axis A1 together with the first housing 100 and the other end 254 connected to the first housing 100 in such a manner that it can rotate about the first hinge axis A1 which is parallel to the second hinge axis A2. An end 252 of the first dual-axis hinge member 250 has a first radius of curvature and the other end 254 thereof has a second radius of curvature which is the same as the first radius of curvature.

The first dual-axis hinge member 250 extends along a vertical direction in the orientation as pictured. The ends 252 and 254 of the hinge member 250 are rounded when viewed from the side. The rounded ends 252 and 254 have a predetermined radius for smooth sliding rotational movement within the coupling means.

The second dual-axis hinge member 260 has an end 262 connected to the second housing 200 in such a manner that the end 262 can rotate about the first hinge axis Al together with the first housing 100 and the other end 264 connected to the first housing 100 in such a manner that it can rotate about the first hinge axis A1 which is parallel to the second hinge axis A2. An end 262 of the second dual-axis hinge member 260 has a first radius of curvature and the other end 264 thereof has a second radius of curvature which is the same as the first radius of curvature.

The second dual-axis hinge member 260 is straight and extends along a vertical direction in the orientation as shown. The ends 262 and 264 of the second dual-axis hinge member 260 are also rounded with a predetermined radius for smooth sliding rotational movement within the coupling means.

As shown in FIG. 3, the coupling means include a pair of first hinge slots 271 and 272 formed on both corners of the first housing 100 and a pair of second hinge slots 281 and 282 formed on both corners of the second housing 200. The first hinge slots 271 and 272 are parallel and occupy the same horizontal plane. The second hinge slots 281 and 282 are also parallel and occupy the same horizontal plane. The first and second hinge slots 271, 272, 281, and 282 are mirror images of each other.

The holding means include a first holding means 251 formed on the first dual-axis hinge member and a second holding means 261 formed on the second dual-axis hinge member 260. The first holding means 251 is formed on the bottom surface 253 of the first dual-axis hinge member in a predetermined shape. The first holding means 251 is a groove recessed from the bottom surface 253 with a cylindrical shape.

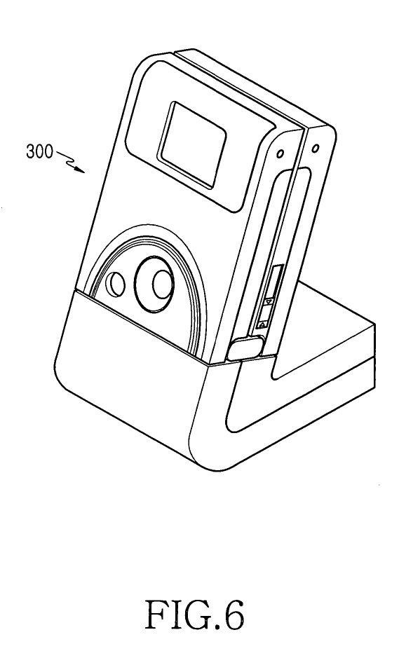

When the portable digital communication apparatus is to be retained on a charger as shown in FIG. 6, the first and second holding means 251 and 261 are inserted onto a protrusion (not shown) formed on the charger 300 in the vertical direction or with a slight slant from the vertical direction, while the first and second housings 100 and 200 are folded on each other, to stably retain the apparatus. FIG. 6 shows the portable digital communication apparatus retained on the charger 300 with a slight slant from the vertical direction.

When the second housing 200 is completely folded on the first housing 100 as shown in FIGS. 1 and 2, the front end surface 103 of the first housing 100 is positioned adjacently to the front end surface 203 of the second housing 200 on the same plane while the first and second holding means 251 and 261 are exposed. The first and second housings 100 and 200 are positioned on top of each other when the second housing 200 is completely folded on the first housing 100. The second housing 200 is positioned parallel to the first housing 100 when the second housing 200 is completely unfolded from the first housing 100. The first and second dual-axis hinge member 250 and 260 are positioned perpendicularly to the first and second housings 100 and 200, respectively, when the second housing 200 is completely folded on the first housing 100.

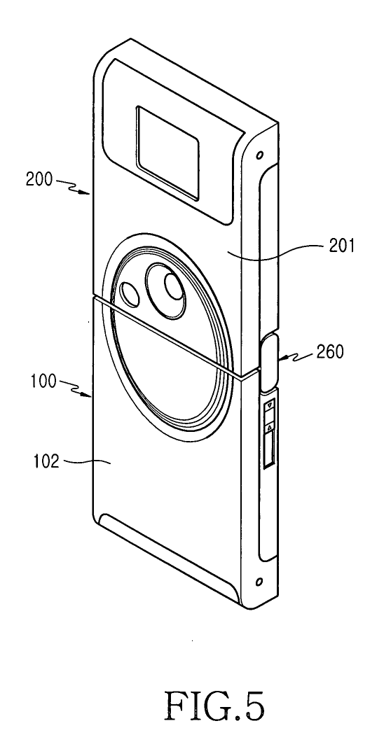

When the second housing 200 is completely unfolded from the first housing 100 as shown in FIGS. 4 and 5, the front end surface 103 of the first housing contacts the front end surface 203 of the second housing while facing it, the first and second housings 100 and 200 are positioned parallel to each other, and the first and second holding means 251 and 261 are hidden. The second housing 200 is positioned parallel to the first housing 100 when the second housing 200 is completely unfolded from the first housing 100.

The first and second dual-axis hinge member 250 and 260 are positioned parallel to the first housing 100, to the second housing 200, or to both first and second housings 100 and 200 when the second housing 200 is completely unfolded from the first housing 100.

As shown in FIG. 4, the first housing has a keypad 110 made up of an array of number of keys positioned on the top surface 101 thereof and a microphone device 112 positioned adjacently to the keypad 110. The second housing has a speaker device 220 positioned on the bottom surface 202 thereof and a main display device 222 positioned adjacently to the speaker device 220. The main display device 222 is made up of an LCD.

As shown in FIG. 4, the first housing 100 has camera-related keys positioned on the lateral surface 104 thereof, particularly a camera operation key 106, a zoom-in key 107, and a zoom-out key 108.

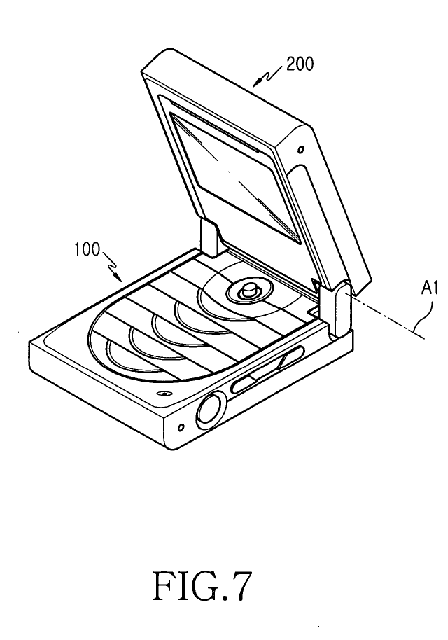

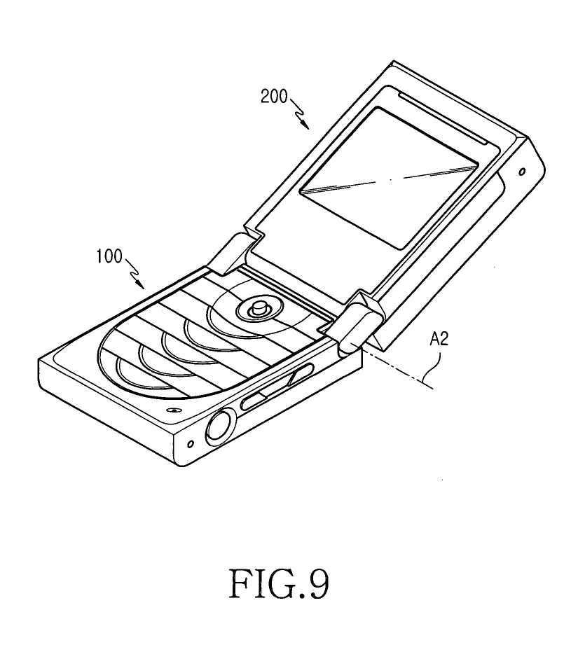

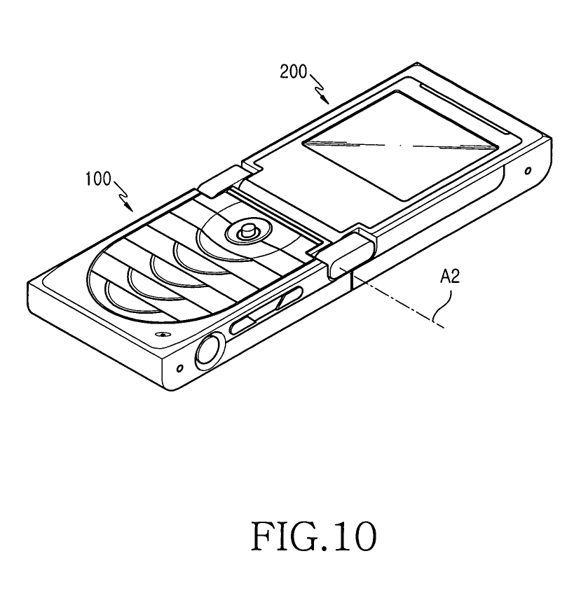

As shown in FIGS. 7 to 10, the portable digital communication apparatus according to the present invention is opened/closed in three steps. More particularly, the second housing 200 is rotated about the first hinge axis A1 at a first angle and is rotated about the second hinge axis A2 at a second angle. The first angle is 0-90° and the second angle is 90°-180°. The second housing 200 stops at a third angle. FIG. 9 shows the portable apparatus used in a phone mode and FIG. 10 shows the portable apparatus used in a camera mode.

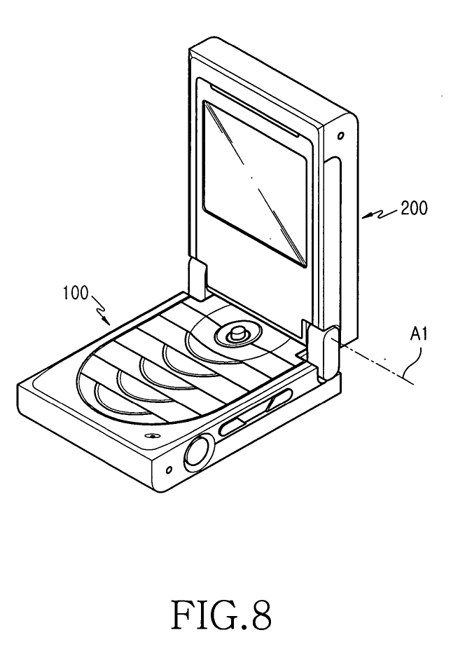

FIGS. 7 and 8 shows the rotation of the second housing 200 about the first hinge axis A1 up to 90°. FIGS. 9 and 10 shows the rotation of the second housing 200 about the second hinge axis A2 up to 180°. The second housing stops at an angle of about 130°-150° as shown in FIG. 9.

Preferably, the rotational force of the rotation about the first hinge axis A1 is smaller than that about the second hinge axis A2. Particularly, the folding/unfolding force provided by a hinge module (not shown) positioned within an end of the first or second dual-axis hinge member 250 or 260 is smaller than that provided by a hinge module (not shown) positioned within the other end of the first or second dual-axis hinge member 250 or 260. When the second housing 200 is unfolded from the first housing 100, the second housing 200 first rotates about the first hinge axis A1 and, after rotating up to 90°, rotates about the second hinge axis A2. The second housing 200 stops at the third angle. This may be realized by a hinge module (not sown) including a conventional hinge housing, a shaft, a cam, and a spring, as will be easily understood by those skilled in the art. The folding/unfolding force of the hinge module (not shown) is an elastic force provided by a conventional spring. Modification of the conventional hinge shaft or cam may enable the second housing 200 to stop at the third angle.

In summary, the rotational force of the second housing 200 rotating about the first hinge axis A1 is different from that about the second hinge axis A2 and the folding/unfolding force about the second hinge axis A2 is larger than that about the first hinge axis A1. During the unfolding of the second housing 200, the second housing 200 performs a first rotational motion about the first hinge axis A1 at the first angle and, after completing the first rotational motion, performs a second rotational motion about the second hinge axis A2 at the second angle. Preferably, the second housing 200 receives a stopping force from a hinge module (not shown) at an angle of about 90° and proceeds the following rotational motion about the second hinge axis A2.

The hinge module (not shown) is not necessarily positioned on the first and second dual-axis hinge members 250 and 260 and may be positioned within the front end of the first or second housing 100 or 200.

Preferably, the first and second housings 100 and 200 constituting the portable apparatus according to the present invention is positioned with a symmetry about the dual-axis hinge members 250 and 260.

As mentioned above, the portable apparatus according to the present invention can be stably opened/closed and stably retained on a charger during charging. Particularly, the apparatus has holding means for retaining the apparatus during charging positioned on dual-axis hinge members with an aesthetically pleasant appearance. In addition, the present invention combines the appearance of a portable apparatus and a digital camera giving the user the feeling of a camera when using the apparatus.

While the invention has been shown and described with reference to certain preferred embodiments thereof, it will be understood by those skilled in the art that various changes in form and details may be made therein without departing from the spirit and scope of the invention as defined by the appended claims.

1. A portable digital communication apparatus comprising:
a first housing;
a second housing;
a dual-axis hinge member connected to the first housing in such a manner that it can rotate about a first hinge axis and connected to the second housing in such a manner that it can rotate about a second hinge axis which is parallel to the first hinge axis to rotatably connect the first and second housings;
at least one coupling means for connecting the dual-axis hinge member to the first and second housings, respectively; and
at least one holding means positioned on the dual-axis hinge member to maintain a retaining position.

2. A portable digital communication apparatus as claimed in claim 1, wherein a pair of dual-axis hinge members are provided.

3. A portable digital communication apparatus as claimed in claim 1, wherein the coupling means comprises first hinge slots formed on both corners of the first housing, and second hinge slots formed on both corners of the second housings.

4. A portable digital communication apparatus as claimed in claim 1, wherein the holding means comprises a groove formed on a surface of the dual-axis hinge member.

5. A portable digital communication apparatus as claimed in claim 4, wherein the groove has the shape of a cylinder.

6. A portable digital communication apparatus as claimed in claim 1, wherein the first housing includes a keypad made up of an array of a number of keys positioned on the top surface thereof and a microphone device positioned adjacent to the keypad, and the second housing includes an auxiliary display device positioned on the top surface thereof, a camera lens positioned adjacent to the auxiliary display device, a speaker device positioned on the bottom surface thereof, and a main display device positioned adjacent to the speaker device.

7. A portable digital communication apparatus as claimed in claim 1, wherein, when the second housing is completely folded on the first housing, the front end surface of the first housing and the front end surface of the second housing are positioned adjacent to each other in the same plane and the coupling means is exposed and, when the second housing is completely unfolded from the first housing, the front end surface of the first housing contacts the front end surface of the second housing while facing it, the first and second housings are positioned parallel to each other, and the coupling means is hidden.

8. A portable digital communication apparatus as claimed in claim 1, wherein the dual-axis hinge member has a rounded end.

9. A portable digital communication apparatus as claimed in claim 1, wherein the first housing has a charging terminal port positioned on the front end surface thereof.

10. A portable digital communication apparatus as claimed in claim 1, wherein the second housing is adapted to rotate about the first hinge axis at a first angle of 0-90° and to rotate about the second hinge axis at a second angle of 90°-180°.

11. A portable digital communication apparatus as claimed in claim 10, wherein the rotational force of the second housing rotating about the first hinge axis is different from the rotational force about the second hinge axis, the folding/unfolding force about the second hinge axis is larger than the folding/unfolding force about the first hinge axis, and, during unfolding operation of the second housing, the second housing performs a first rotational motion about the first hinge axis at the first angle and, after completing the first rotational motion, performs a second rotational motion about the second hinge axis at the second angle.

12. A portable digital communication apparatus comprising:
a plate-shaped first housing;
a plate-shaped second housing adapted to be positioned on top of the first housing when completely folded and to be positioned parallel to the first housing when completely unfolded; and
at least one dual-axis hinge member having a retaining groove of a predetermined shape to maintain a retaining position during charging and rotatably connected to the first and second housings, respectively.

13. A portable digital communication apparatus as claimed in claim 12, wherein the dual-axis hinge member is straight and both ends thereof have a predetermined radius of curvature.

14. A portable digital communication apparatus as claimed in claim 12, wherein the groove is a cylindrical recess on a surface of the dual-axis hinge member.

15. A portable digital communication apparatus as claimed in claim 12, wherein the dual-axis hinge member is perpendicular to the first and second housings when the second housing is completely folded on the first housing and the dual-axis hinge member is parallel to the first and second housings when the second housing is completely unfolded from the first housing.

16. A portable digital communication apparatus as claimed in claim 12, wherein the groove is exposed to the exterior when the second housing is completely folded on the first housing and is hidden when the second housing is completely unfolded from the first housing.

17. A portable digital communication apparatus as claimed in claim 12, wherein the dual-axis hinge member is positioned between the first and second housings symmetrical about both the vertical and horizontal planes.

18. A portable digital communication apparatus as claimed in claim 12, wherein said apparatus is retained on a retaining table when the second housing is completely folded on the first housing.

19. A portable digital communication apparatus as claimed in claim 12, wherein, during unfolding operation of the second housing, the second housing performs a first rotational motion about a first hinge axis and a second rotational motion about a second hinge axis which is parallel to the first hinge axis, the first and second rotational motions are provided with different rotational forces, the rotational force of the second rotational motion is larger than the rotational force of the first rotation motion, and the second housing performs the first rotational motion about the first hinge axis at a first angle and, after completing the first rotational motion, performs the second rotational motion about the second hinge axis at a second angle.

20. A portable digital communication apparatus comprising:
a first housing;
a second housing;
a dual-axis hinge member having a first end connected to the first housing and a second end connected to the second housing;
wherein:
the first housing is rotatable about a first axis with respect to the dual-axis hinge member, the first axis running through the first end; and,
the second housing is rotatable about a second axis with respect to the dual-axis hinge member, the second axis running through the second end.
